(19) United States
(12) Patent Application Publication
(10) Pub. No.: US 2014/0315183 A1
(43) Pub. Date: Oct. 23, 2014

(54) System for Exhibiting Different Motifs for Facades of Buildings

(71) Applicant: Muro Cortina Modular Group, S.L., Barcelona (ES)

(72) Inventor: Antonio Garcia-Valdecasas Canet, Barcelona (ES)

(73) Assignee: Muro Cortina Modular Group, S. L., Barcelona (ES)

(21) Appl. No.: 14/351,648

(22) PCT Filed: Oct. 17, 2012
(86) PCT No.: PCT/ES2012/000270

§ 371 Date: Apr. 14, 2014

(30) Foreign Application Priority Data
Oct. 18, 2011 (ES) P201101122

(51) Int. Cl. G09F 19/12

(52) U.S. Cl. CPC G09F 19/12
USPC 434/367

(57) ABSTRACT

System for exhibiting different motifs for facades of buildings of the type intended to be superimposed on a facade of a building and comprising a large exhibiting surface and lighting means; which comprises—a plurality of transparent plates which are arranged on the outside and at a distance from a facade of said building;—a modular structure which comprises: supporting brackets which are arranged at different levels, are fixed to said building at a first end and project from said facade of the building; vertical tubes which are fixed on a second end of said supporting brackets by an intermediate area and are at a distance from said facade of the building; clamps for fastening said transparent plates to said vertical tubes; maintenance walkways and cable management trays fixed to the supporting brackets and situated at different levels within the exhibiting surface;—an array of LEDs which is situated behind the transparent plates and is oriented towards said transparent plates;—a computerized unit for controlling the lighting means, and;—autonomous electrical power supply means.

### OBJECT OF THE INVENTION

The present invention relates to a system for exhibiting different motifs for facades of buildings of the type intended to be superimposed on a facade of a building and comprising an exhibiting surface and lighting means.

### FIELD OF APPLICATION OF THE INVENTION

This invention is applicable to the manufacturing of communication and advertising systems applicable to the facades of public and private buildings, airports, transport stations and to facades of any kind.

### BACKGROUND OF THE INVENTION

The use of posters and billboards for the presentation of different motifs in different environments, either of the advertising or informative type, is a standard practice nowadays.

Advertising billboards and poster displays intended to be fixed on vertical walls generally have a rear surface delimited by a perimeter frame intended to contain a printed sheet with the motifs to be exposed in its interior, this sheet being generally covered by means of a transparent cover on its frontal area.

This type of support has sizing limitations due to its own structure and configuration.

The use of large advertising posters intended to be applied on the surfaces of buildings is also currently known.

This application is traditionally carried out by gluing paper posters to the wall or to boards fixed on the wall, which requires the intervention of labor every time the poster in question is replaced. These posters, as well as the billboards and the wall displays mentioned above, have a significant limitation in terms of the surface to be covered, which makes the attainment of a large format exhibiting surface difficult.

Another known technique is the application of posters in independent boards that are elevated to a convenient position, as described in document EP-A-0453359, for example.

Parent ES2119407T3 also describes a device to apply large sized information supports, such as posters, illustrations and similar items, on vertical surfaces, particularly on buildings, which is based on the use of flexible posters or illustrations with the quality to withstand the impact of rain and snow and presenting resistance against deformation such that they can be suspended on one side. The foregoing is achieved by laminating photographic paper with a plastic sheet on one or both faces, or applying the illustration or decoration to a weave, a textile with the necessary resistance.

This device, just like the previous ones, has certain limitations with respect to the surface to be covered, the risk of accelerated breakage or deterioration due to the effect of the wind, and a limited exposure capacity because it only relates to static motifs, which means that replacing the entirety of the flexible, printed and conveniently protected sheet is necessary to change the information or the advertising being exposed.

### DESCRIPTION OF THE INVENTION

The system for exhibiting different motifs for facades of buildings object of the invention of the type intended to be superimposed on a facade of a building and comprising a large exhibiting surface and lighting means presents construction particularities intended to provide it with a modular nature, which allows forming an exhibiting surface with variable amplitudes and which is adaptable to facades of different sizes.

This modular nature therefore eliminates the dimensional limitations of the exhibiting surface of the printed sheets and posters that are currently used.

Another of the objectives of the invention is the formation of a rigid exhibiting surface by means of transparent plates arranged on a supporting modular structure.

Another of the objectives of the invention is the attainment, by means of this system, of the combined exhibition of static informative or advertising motifs with illuminated signs showing dynamic or changing motifs, either for advertising purposes or for the communication of any event, emergency message, signaling or any other to the outside.

Another of the objectives of the invention is to provide the system with autonomous electrical power supply means to guarantee the sustainability thereof.

Another of the objectives of the invention is to guarantee a confortable and safe access to any point of the system for exhibiting motifs installed on a facade for the operators by means of the use of maintenance walkways arranged on a modular structure that serve as support for the transparent plates forming the exhibiting surface and lighting means for exhibiting the illuminated messages with changing motifs.

Another of the objectives of the invention is the undertaking of the system for exhibiting motifs such that it allows the passage of light through the same in order for its use on facades of buildings having exterior openings does not constitute a problem in terms of taking advantage of natural light.

In order to achieve the objectives proposed herein in a simultaneous manner, this system for exhibiting different motifs for facades of buildings comprises certain characteristics contained in claim 1, according to which it comprises:

a plurality of transparent plates which are arranged on the outside and at a distance from a facade of said building, said plurality of plates forming an exhibiting surface with adjustable dimensions for the possible support and exhibition of static informative or advertising motifs;

a modular structure which comprises: supporting brackets which are arranged at different levels, which are fixed on said building at a first end and project from said facade of the building; vertical tubes which are fixed on a second end of said supporting brackets by an intermediate area and are at a distance from said facade of the building; clamps for fastening said transparent plates to said vertical tubes; maintenance walkways and cable management trays fixed on the supporting brackets and situated at different levels within the exhibiting surface, formed by said transparent plates, and the facade of the building;

an array of LEDs (light-emitting diodes) which is situated behind the transparent plates, oriented towards said transparent plates and constituting lighting means for exhibiting illuminated signs, with dynamic or changing motifs, visible through said transparent plates;

a computerized unit for controlling the lighting means and the formation of said illuminated signs, and;

autonomous electrical power supply means, constituted by photovoltaic plates arranged on said building.

Other additional characteristics of the invention, contained in the dependent claims of the invention, contemplate the formation of the transparent plates in glass, methacrylate or in similar materials to resist impacts of a moderate intensity without breaking, thereby guaranteeing the integrity of the exhibiting surface.

According to the invention, the static motifs can be applied to the transparent plates by means of adhesion, silk-screening, printing or any other similar technique.

Another characteristic of the invention is that the LEDs forming the lighting means are arranged on fastening profiles made of opaque materials (aluminum, iron or similar) or translucent materials (glass, methacrylate or similar) forming parallel alignments and which are fixed on the supporting structure of the transparent plates. This arrangement of the LEDs allows the illuminated sign, formed by the same, to reach the entirety or part of the total surface of the system of the invention, thereby obtaining the modularity mentioned above.

The fastening profiles of the LEDs are preferably arranged horizontally and fixed to the vertical tubes of the supporting structure of the transparent plates.

The LED system will be preferably the one described above, although a LED curtain may be installed in its stead.

According to the invention, the static motifs arranged on the transparent plates are formed with a translucent material, which allows the light emitted by the array of LEDs to pass through the same, and prevents said static motifs from undermining the potential illuminated messages emitted by said array of LEDs.

With these characteristics, the invention allows obtaining, by means of a single system, the exhibition of static motifs or advertising in a simultaneous manner or in combination with the exhibition of illuminated signs with dynamic or changing advertising, informative, or any other type of motifs.

The invention has envisaged the arrangement of the photovoltaic plates on the facade of the building that is exposed to the sun for a greater number of hours, or on the facade that is the most unfavorable for the presentation of the motifs to be exhibited. These photovoltaic plates may be arranged on the upper area of the building or on one of said facades, using the same structure described above as support.

### DESCRIPTION OF THE FIGURES

In order to complete the invention being described, and with the purpose of facilitating a better comprehension of the characteristics of the invention, a set of drawings is attached to the present specification representing the following in an illustrative rather than limitative manner:

FIG. 1 shows a schematic view of a profile of an example of an embodiment of the system for exhibiting different motifs for facades of buildings according to the invention, applied to a building.

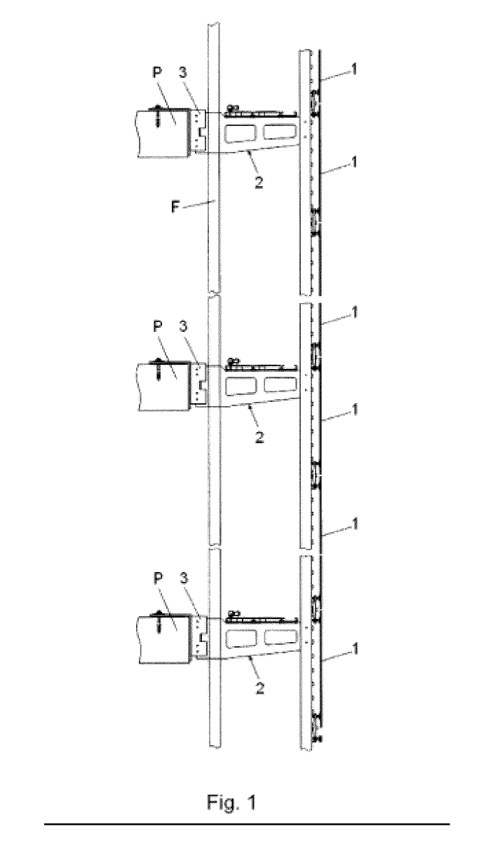

FIG. 2 shows an enlarged detail of the previous figure.

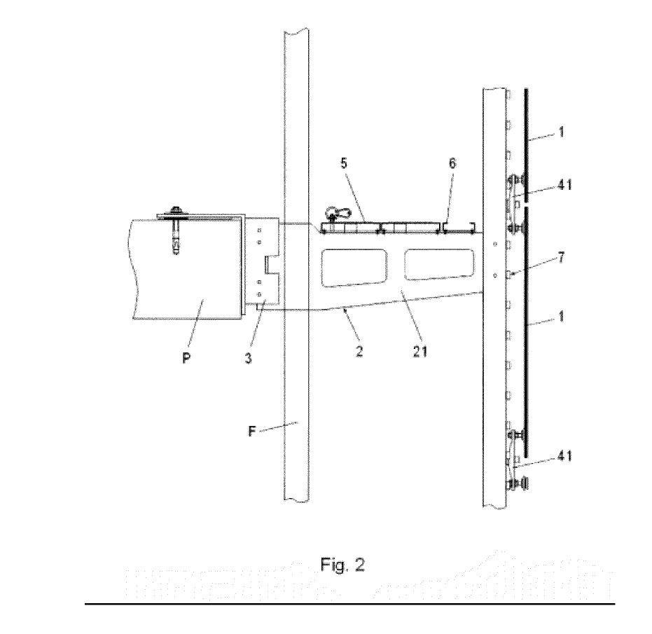

FIG. 3 shows a frontal elevational and schematic view of a portion of the system for exhibiting motifs, wherein some of the frontal plates carrying static advertising motifs and some of the transparent plates sectioned to allow the visualization of the array of LEDs arranged behind the same can be observed.

### PREFERRED EMBODIMENT OF THE INVENTION

In the example of an embodiment shown in the figures attached, the system for exhibiting different motifs for facades of buildings comprises a plurality of transparent plates (1), in this case made of tempered glass, which are arranged on the outside and at a distance from a facade (F) of a building; said transparent plates (1) forming an exhibiting surface.

The transparent plates (1) are arranged with respect to the building by means of a modular structure, referenced as a whole as (2), which in this example of an embodiment comprises supporting brackets (21) arranged at different levels, specifically in correspondence with the successive floors (P) of the building.

These supporting brackets (2) are fixed on the building at a first end by means of an anchoring support or plate (3), which may present different configurations depending on the characteristics and typology of the building in question just like the supporting brackets (21).

Said modular structure (2) also comprises vertical tubes (4) fixed on a second end of said supporting brackets (21), such that said vertical tubes (4) are sensibly parallel and are at a distance from said facade (F) of the building.

Said modular structure also comprises clamps (41) fixed on the vertical tubes (4), forming the fastening means of the transparent plates (1).

Said modular structure (2) also comprises maintenance walkways (5) and cable management trays (6), which extend throughout the supporting brackets (21) situated at the same level within the exhibiting surface constituted by the transparent plates (1) and the facade (F) of the building.

An array of LEDs (7) is arranged on the vertical tubes (4) and behind the transparent plates (1), which forms the lighting means for the exhibition of illuminated signs with dynamic or changing motifs visible through the transparent plates (1).

This array (7) is constituted by a plurality of LEDs (71) arranged on fastening profiles (72) and forming parallel alignments, horizontal in this case, fixed to the vertical tubes (4).

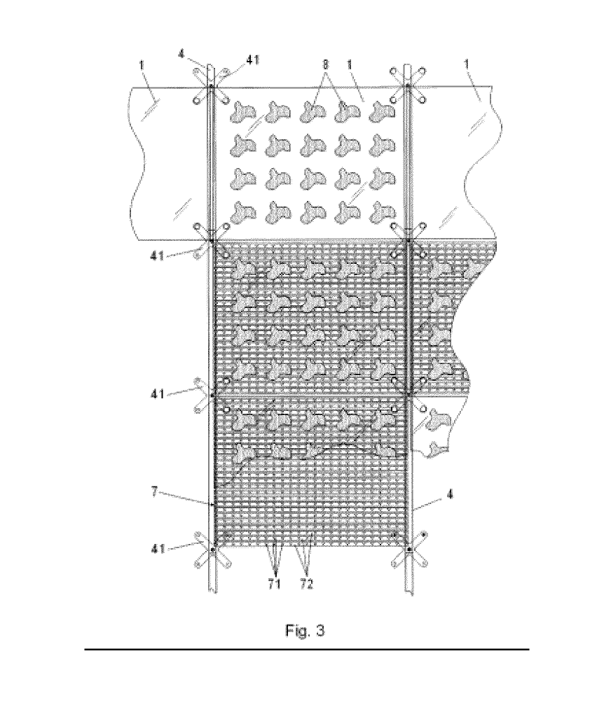

As shown in FIG. 3, the transparent plates (1) form an exhibiting surface suitable for the support of static informative or advertising motifs (8), which may be adhered, silk-screened or fixed by any other means to said transparent plates (1). In a preferred embodiment, said static motifs are made of translucent materials, such that they allow the passage through the same of the light emitted by the array (7) of LEDs when the same is in operation.

This way, the system allows carrying out the exhibit of static motifs (8) associated with the transparent plates (1) in combination with the dynamic or changing motifs generated by the array (7) of LEDs (71) and projected to the outside by means of the transparent plates (1).

As mentioned above, this system incorporates a computerized unit, not represented, for controlling the lighting means and the formation or programming of different illuminated signs, and autonomous electrical power supply means constituted by photovoltaic plates, not represented, arranged on said building.

After describing the nature of the invention, as well as an example of a preferred embodiment, in a sufficient manner, it is hereby stated for all purposes that the materials, form, size and arrangement of the elements described above can be modified as long as said modification does not entail an alteration of the essential characteristics of the invention claimed below.

1. A system for exhibiting different motifs for facades of buildings of the type intended to be superimposed on a facade of a building and comprising a large exhibiting surface and lighting means comprising:
a plurality of transparent plates which are arranged on the outside and at a distance from a facade of said building, said plurality of plates forming an exhibiting surface with adjustable dimensions for the possible support and exhibition of static informative or advertising motifs;
a modular structure comprising:
supporting brackets which are arranged at different levels, fixed to said building at a first end and projecting from said facade of the building;
vertical tubes which are fixed on a second end of said supporting brackets by an intermediate area and are at a distance from said facade of the building;
clamps for fastening said transparent plates to said vertical tubes;
maintenance walkways and cable management trays fixed to the supporting brackets and situated at different levels within the exhibiting surface;
an array of LEDs which is situated behind the transparent plates and is oriented towards said transparent plates, constituting the lighting means for the exhibition of illuminated signs with dynamic or changing motifs, visible through said transparent plates;
a computerized unit for controlling the lighting means and for forming said illuminated signs, and;
autonomous electrical power supply means, constituted by photovoltaic plates arranged on said building.

2. The system of claim 1, in which the transparent plates are made of glass, methacrylate or similar materials.

3. The system of claim 1, in which the static motifs are applied to the transparent plates by means of adhesion, silk-screening or printing.

4. The system of claim 1, in which the LEDs forming the lighting means are arranged on fastening profiles forming parallel alignments and fixed to the supporting structure.

5. The system of claim 4, in which the fastening profiles of the LEDs are arranged horizontally and fixed to the vertical tubes of the supporting structure.

6. The system of claim 1, in which the static motifs arranged on the transparent plates are made of a translucent material.
